(19) United States
(12) Patent Application Publication
(10) Pub. No.: US 2026/0260337 A1
(43) Pub. Date: Sep. 3, 2026

(54) ANOMALY DETECTION IN ACOUSTIC IMAGING DATA BY SIMILARITY SEARCH

(71) Applicant: Evident Canada, Inc., Quebec (CA)

(72) Inventor: Ivan C. Kraljic, Saint-Gervais (CA)

(73) Assignee: Evident Canada, Inc., Quebec (CA)

(21) Appl. No.: 19/553,371

(22) Filed: Mar. 1, 2026

Related U.S. Application Data
(60) Provisional application No. 63/764,729, filed on Feb. 28, 2025.

(51) Int. Cl. G06T 7/00

(52) U.S. Cl. CPC G06T 7/001; G06T 2207/20032; G06T 2207/20224; G06T 2207/30136

(57) ABSTRACT

A System includes: a probe assembly that acquires non-destructive test data at a plurality of positions on an object; and a processor circuit, the processor circuit configured to: generate reference images corresponding to the plurality of positions based on the acquired non-destructive test data; select a candidate image from among the reference images, the candidate image associated with a position from the plurality of positions; determine similarity scores between the candidate image and at least a subset of the remaining reference images; identify, based on the similarity scores, a reference image from among the at least a subset of the remaining reference images for comparison with the candidate image; and detect an anomaly associated with the object at the position associated with the candidate image utilizing a similarity threshold and a similarity score of the candidate image and the reference image.

### CROSS-REFERENCE TO RELATED APPLICAITON

This application claims benefit under 35 U.S.C. § 119(e) to U.S. Provisional Application No. 63/764,729, filed February 28, 2025, entitled “ANOMALY DETECTION IN ACOUSTIC IMAGING DATA BY SIMILARITY SEARCH,” the entire disclosure of which is hereby incorporated by reference herein.

### BACKGROUND

### Technical Field

This document pertains generally, but not by way of limitation, to apparatus and techniques for non-destructive inspection such as facilitating acoustic inspection, and more particularly, to apparatus and techniques for performing automated or semi-automated detection of anomalies in acoustic imaging data obtained for non-destructive inspection of objects such as composite structures.

### Discussion of Art

Non-destructive testing (NDT) (also referred to as non-destructive inspection) can refer to use of one or more different techniques to inspect regions on or within an object, such as to ascertain whether flaws or defects exist, or to otherwise characterize the object being inspected. Examples of non-destructive test approaches can include use of an eddy current testing approach where electromagnetic energy is applied to the object and resulting induced currents on or within the object are detected, with the values of a detected current (or a related impedance) providing an indication of the structure of the object under test, such as to indicate a presence of a crack, void, porosity, or other inhomogeneity.

Another approach for NDT can include use of an acoustic inspection technique, such as where one or more electroacoustic transducers are used to insonify a region on or within the object under test, and acoustic energy that is scattered or reflected can be detected and processed. Such scattered or reflected energy can be referred to as an acoustic echo signal. Generally, such an acoustic inspection scheme involves use of acoustic frequencies in an ultrasonic range of frequencies, such as including pulses having energy in a specified range that can include values from, for example, a few hundred kilohertz, to tens of megahertz, as an illustrative example. Various ultrasonic testing (UT) approaches are capable of detecting different features or defect orientations. For example, zero-degree phased-array (PA) and Total Focusing Method (TFM) are sensitive to planar reflectors parallel to the surface (backwall, laminations). Angle-beam PA and TFM can detect planar flaws at a specified angle or angular range. Other methods can be used for defects that scatter the incident wave in all directions. Time-of-flight diffraction (TOFD) and phase coherence imaging (PCI) can be used for detection of small, point-like flaws and crack tips.

### SUMMARY

In one aspect, the present disclosure provides a system for detecting anomalies in non-destructive test data. The system includes a probe assembly configured to acquire non-destructive test data at a plurality of positions on an object and a processor circuit communicatively coupled to the probe assembly. The processor circuit is configured to generate reference images corresponding to the plurality of positions based on the acquired non-destructive test data, select a candidate image from among the reference images, determine similarity scores between the candidate image and at least a subset of remaining reference images, and identify, based on the similarity scores, a reference image from among the at least a subset of remaining reference images for comparison with the candidate image. The processor circuit is further configured to detect an anomaly associated with the object at the position associated with the candidate image utilizing (i) a similarity threshold and (ii) a similarity score of the candidate image and the reference image..

In one aspect, the present disclosure provides a method for detecting anomalies in non-destructive test data. The method includes acquiring non-destructive test data at a plurality of positions on an object and generating reference images corresponding to the plurality of positions based on the acquired non-destructive test data. The method further includes selecting a candidate image from the reference images, determining similarity scores between the candidate image and at least a subset of remaining reference images, and identifying, based on the similarity scores, a reference image to the candidate image from the at least a subset of remaining reference images. The method further includes detecting an anomaly associated with the object at the position of the candidate image utilizing (i) a similarity threshold and (ii) a similarity score of the candidate image and the reference image.

In one aspect, the present disclosure provides a method for detecting anomalies in non-destructive test data using vectorized representations. The method includes acquiring non-destructive test data at a plurality of positions on an object, generating reference images corresponding to the plurality of positions based on the acquired non-destructive test data, and generating a vector database comprising vectorized representations of the reference images. The method further includes pairing each reference image to an Nth reference image based on similarity scores determined between each reference image and at least a subset of remaining reference images, wherein N is a selected rank in a similarity ranking of the reference images. The method further includes identifying one or more anomalies associated with the object based on paired reference images having similarity scores satisfying a similarity threshold.

### BRIEF DESCRIPTION OF THE DRAWINGS

FIG. 1 is a block diagram of a non-destructive testing assembly, according to at least one embodiment of the present disclosure.

FIG. 2 illustrates a flowchart of a method for establishing a reference data set for use in anomaly detection of acoustic image data, according to at least one embodiment of the present disclosure.

FIG. 3 illustrates a flowchart of a method for anomaly detection of acoustic image data, according to at least one embodiment of the present disclosure.

FIG. 4 is a flowchart of a method for establishing a reference data set for use in anomaly detection of acoustic image data, according to at least one embodiment of the present disclosure.

FIG. 5 is a flowchart of a method for anomaly detection of acoustic image data, according to at least one embodiment of the present disclosure.

FIG. 6 is a flowchart of a method for anomaly detection of acoustic image data using vectorization on the images, according to at least one embodiment of the present disclosure.

FIG. 7 shows a user interface displaying different views of a composite image generated based on acoustic imaging data for a wind turbine, according to at least one embodiment of the present disclosure.

FIG. 8 is a difference image based on the composite image of FIG. 7, according to at least one embodiment of the present disclosure.

FIG. 9 is a similarity plot corresponding to imaging data of FIG. 7, according to at least one embodiment of the present disclosure.

FIG. 10 is a block diagram of an example comprising a machine upon which any one or more of the techniques (e.g., methodologies) discussed herein may be performed, according to at least one embodiment of the present disclosure.

### DESCRIPTION

Non-destructive testing (NDT) of manufactured structures can be performed using an acoustic technique, such as involving ultrasonic inspection using a phased-array transducer architecture and associated processing (e.g., beamforming and imaging). For large structures (e.g., metal or composite), an associated volume of acquired acoustic inspection data can be very large for each article being inspected and across a production lot of such articles. For example, in inspection of composite structures such as wind turbine blades, such a volume can include hundreds of thousands of images produced using acoustic inspection.

Qualified human inspectors generally spend many hours reviewing such data, generally using a manual approach involving inspecting images for flaw indications and annotating images to identify such indications. Since imaging related to acoustic inspection can have high variability and complex features, it is challenging to develop software-based techniques to help to automatically identify flaws or indicia of inspection configuration anomalies. The present inventor has, among other things, developed techniques to use an image similarity search approach to augment or accelerate human inspection. Such an approach can also include use of techniques to flag anomalies associated with an inspection configuration.

In an example, a non-destructive test (NDT) apparatus can include a probe assembly to acquire inspection data using an acoustic technique. The probe assembly can be communicatively coupled with at least one processor circuit. The processor circuit may apply a machine-implemented similarity analysis as shown and described herein. For example, such an approach can be used to detect a flaw or other feature by indicating when respective acoustic images in a series of such images indicate an anomaly as a result of the similarity analysis, such as by being different by a corpus of images in a reference data set.

As an example, a FAISS (Facebook AI Similarity Search) technique or other vector similarity determination can be made, such as where a respective acoustic image is represented as a vector, and a Euclidean distance (e.g., L2 norm) or dot product is performed between the vectorized image and vectorized representations of reference images. The most similar image in the reference data set can be identified. In some embodiments, where the metric is a distance metric such as Euclidean (L2) distance, smaller distance values indicate higher similarity and larger distance values indicate lower similarity. In other embodiments, where the metric is a similarity metric such as a dot product between vectors (e.g., optionally after vector normalization), larger dot-product values indicate higher similarity and smaller dot-product values indicate lower similarity. If the Euclidean distance or other metric indicates dissimilarity above a specified threshold (consistent with the metric definition), even in the case of the most similar image in the reference data set, such a result provides an indication that the respective acoustic image being compared is anomalously different from the reference data set.

According to various embodiments, a system for detecting anomalies in NDT data is provided. The system may be implemented to facilitate automated identification of anomalies in inspection data acquired from objects such as composite structures, metallic components, or other articles subject to non-destructive evaluation. The system can be adapted for use with a variety of NDT modalities that generate image data, including but not limited to ultrasonic and electromagnetic inspection techniques.

The system may include a probe assembly operable for acquiring non-destructive test data at a plurality of positions of an object. The probe assembly can include, for example, an array of electroacoustic transducers, such as a phased-array ultrasonic probe, that may be scanned across the surface or volume of a test object. In some embodiments, the probe assembly may be configured to acquire acoustic imaging data, such as B-scans, C-scans, or other multi-dimensional representations, at discrete or continuous positions along the object. The probe assembly may optionally include coupling media, such as water, gel, or elastomeric interfaces, to facilitate signal transmission, and may be integrated with a test instrument or operated in conjunction with remote processing facilities.

The system may further include a processor circuit communicatively coupled to the probe assembly. The processor circuit may generate reference images based on the NDT data. Each reference image may correspond to a different one of the plurality of positions used to acquire the non-destructive test data. For example, the processor circuit can process raw NDT signals to construct image data for each scanned position. The reference images may represent ultrasonic, electromagnetic (e.g., eddy current), or other inspection data in formattable as images.

The processor circuit may select a candidate image from the set of reference images for further analysis. The candidate image may correspond to a particular position of interest along the object. The processor circuit can determine similarity scores between the candidate image and each of at least a subset of the remaining reference images. The processor circuit may identify an N^{th} most similar reference image, also referred to herein as the N^{th} reference image, to the candidate image based on the similarity scores. The value of N may be selected to exceed the longest expected sequence of consecutive anomalous images, thereby increasing the likelihood that the N^{th} most similar image corresponds to a normal (e.g., non-anomalous) region of the object.

For example, where the candidate image may include an anomaly, the first few reference images that are most similar to the candidate image may be images captured at positions proximate that of the candidate image, and thus may themselves include the same anomaly as the candidate image. By selecting N to be greater than the expected length of consecutive anomalous images, the system may avoid pairing the candidate image with a reference image that also corresponds to the same anomaly.

The processor circuit may select the candidate image from the reference images by iterating through the reference images in sequence, by selecting reference images associated with a user-specified region of interest, and/or by selecting reference images based on one or more criteria. In some embodiments, selection of N is based on an estimated maximum run length of consecutive reference images that correspond to a same anomaly in a scan order. If N is selected below the estimated maximum run length, the reference image having rank N in the similarity ranking for an anomalous candidate image may also correspond to the same anomaly (e.g., due to positional proximity or repeated anomaly appearance), and the similarity score between the anomalous candidate image and the selected reference image may not indicate dissimilarity relative to non-anomalous images. If N is selected above the estimated maximum run length, the reference image having rank N in the similarity ranking for an anomalous candidate image is more likely to correspond to a non-anomalous region, and the similarity score between the anomalous candidate image and the selected reference image may more often indicate dissimilarity relative to non-anomalous images.

The N value can be manually selected based on, for example, empirical study of real data with anomalies and knowledge of the manufacturing process. Alternatively, in some embodiments, the processor circuit may determine an initial value and/or a recommended value for the selected rank N in the similarity ranking using inspection statistics accumulated across multiple inspected objects or datasets. The processor circuit may initialize N to a relatively high value, such as approximately one‑half of a dataset length (e.g., a number of reference images in a scan), and execute the anomaly detection technique on a plurality of datasets to generate corresponding anomaly‑score traces (e.g., similarity‑score or distance‑score plots) for the datasets. From the anomaly‑score traces, the processor circuit may identify, for each dataset, a longest run length of consecutive images flagged as anomalous, and may set N based on an aggregate longest observed run length, such as by setting N to the longest observed run length plus a margin (e.g., approximately fifty percent). In such implementations, automatic identification of anomalous runs in the anomaly‑score traces may be performed using a thresholding technique, including variable or adaptive thresholding approaches (e.g., local thresholding), recognizing that threshold selection can introduce false positives or false negatives. Where the objective is to estimate an upper‑bound run length for purposes of selecting N, a coarse or approximate thresholding approach may be utilized. In further embodiments, N may additionally or alternatively be specified or adjusted based on inspector expertise and/or manufacturing inspection statistics, and may be set conservatively (e.g., larger than an expected longest anomalous run).

In some embodiments, automated estimation of N includes classifying similarity scores or anomaly scores to determine a threshold for identifying anomalous runs in an anomaly-score trace. For example, the processor circuit may generate a distribution of anomaly scores for a dataset (e.g., a histogram or empirical cumulative distribution), and may separate the distribution into a baseline group and an outlier group using a clustering or classification technique, such as k-means clustering, Gaussian mixture modeling, or percentile-based partitioning. The processor circuit may select a threshold based on the separation between the baseline group and the outlier group, may identify contiguous segments of reference images having anomaly scores meeting the threshold criterion, and may determine the run lengths of the contiguous segments. The processor circuit may set N based on a maximum run length across the dataset(s) and a margin, for example as described above. In such implementations, isolated misclassifications or short segments in the anomaly-score trace may be disregarded when determining a maximum run length.

The processor circuit may detect an anomaly associated with the object at the position of the candidate image based on the similarity score between the candidate image and the N^{th} most similar reference image satisfying a determined similarity threshold. If the similarity score meets an anomaly criterion defined using the similarity threshold (e.g., falls below or exceeds the threshold depending on the metric), the candidate image may be flagged. For example, for a test object with a uniform shape, most of the reference images will likely be very similar to each other. Thus, if the candidate image is not sufficiently similar to the N^{th} most similar reference image (e.g., the N^{th} image being representative of the bulk of the reference images that do not include anomalies), it can indicate that the candidate image includes an anomaly, such as a defect or data quality issue.

In some embodiments, to form a similarity ranking, the processor circuit may determine a similarity score between the candidate image and each reference image in a searchable set (e.g., at least a subset of remaining reference images), may order the reference images according to the similarity scores to form the similarity ranking, and may select the reference image having rank N in the similarity ranking as the Nth reference image for comparison with the candidate image.

In some embodiments, the similarity scores may be ordered according to the definition of the similarity score. For example, where the similarity score is defined as a similarity metric in which larger values indicate greater similarity (e.g., a correlation-based score or a structural similarity score), the reference images may be ordered in descending order of the similarity scores such that higher-ranked reference images have larger similarity scores. In other embodiments, the similarity score may be defined as a distance or dissimilarity metric in which smaller values indicate greater similarity (e.g., an L2/Euclidean distance between vectorized representations), and the reference images may be ordered in ascending order of the similarity scores such that higher-ranked reference images have smaller distance values. In either case, an Nth reference image for comparison with the candidate image may be selected as the reference image having rank N in the resulting similarity ranking.

The processor circuit may assist selection of the candidate image by generating candidate recommendations based on anomaly scores computed for reference images. In one embodiment, the processor circuit may compute, for each reference image, a respective similarity score relative to a corresponding reference image identified in a similarity ranking (e.g., having rank N), and may derive an anomaly score from the similarity score (e.g., using the similarity score directly or a function of the similarity score). The processor circuit may rank reference images according to the anomaly scores and may present, via the interface, a set of recommended candidate images for review, such as a top-K list of reference images having highest anomaly scores and/or a list of reference images whose anomaly scores meet a threshold criterion. In further embodiments, the recommended candidate images may be filtered based on a user-selected region of interest or based on object position tags associated with the reference images, such that the recommendations are limited to images corresponding to selected portions of the object.

The system may include an interface configured to display the candidate image with an indication of the detected anomaly. The interface can include a graphical user interface, display panel, or other visualization means, and may present the candidate image alongside visual markers, overlays, or annotations highlighting the location and nature of the anomaly.

The devices, systems, and methods disclose herein can prove technological improvements over alternate approaches to anomaly detection in NDT data. Alternate approaches often rely on manual inspection or rule-based algorithms that require extensive parameter tuning, prior knowledge of defect characteristics, or the use of deep learning models trained on large, labeled datasets. These approaches can be labor-intensive, error-prone, and may not generalize well to new inspection scenarios or object geometries.

Various embodiments of the approaches disclosed herein employ a similarity-based anomaly detection technique that leverages the inherent statistical properties of NDT data. By comparing each candidate image to an N^{th} most similar reference image, where N is selected to avoid consecutive anomalous regions, the system can robustly identify anomalies without requiring explicit defect models or exhaustive training data. This approach can be applied in scenarios where most images are expected to be normal and highly similar, such as in the inspection of large composite structures or metallic components. As a result, the system may automatically flag regions of interest for further review, reducing the burden on human inspectors and/or compute resources and improving throughput compared to alternate approaches.

For example, NDT inspections may generate tens of thousands of images per scan. Various approaches disclosed herein can allow for automated identification of defects or data quality issues without manual review of each image. The interface may present flagged candidate images with visual overlays, enabling inspectors to quickly assess and validate anomalies. This can not only accelerate the inspection process but can also reduce the risk of missed defects, contributing to improved accuracy and reliability for NDT inspections.

The processor circuit may generate vectorized representations of the reference images for comparison in an embedding space. Each reference image may be transformed into a feature vector using techniques such as principal component analysis, neural network-based embeddings, or other dimensionality reduction methods. In some embodiments, vectorization may involve flattening pixel intensity values into a one-dimensional array, extracting statistical features (such as mean, variance, or histogram bins), or applying convolutional neural networks to produce compact, learned feature vectors that capture texture, shape, and contrast information. Alternatively, feature extraction may utilize edge detectors, wavelet transforms, or frequency-domain representations to encode structural characteristics of the images. The resulting vectors may be normalized to ensure consistent scaling and facilitate accurate similarity comparisons. Similarity scores between the candidate image and reference images may be determined based on the generated vectorized representations of the images. For example, similarity scores may be determined using a vector distance metric, such as Euclidean distance, or by computing a dot product between vectors. Where the similarity score is a distance metric such as Euclidean distance, vectors corresponding to more similar images typically have smaller Euclidean distance values, and vectors corresponding to less similar images typically have larger Euclidean distance values. Where the similarity score is based on a dot product (e.g., optionally between normalized vectors), more similar images typically produce larger dot-product values, and less similar images typically produce smaller dot-product values.

The processor circuit may store the vectorized representations of the reference images in an image vector database. Such a database can facilitate rapid retrieval and comparison of image vectors (e.g., supporting real-time and/or batch anomaly detection workflows). The image vector database may be implemented using specialized indexing structures, such as KD-trees or approximate nearest neighbor algorithms (e.g., to accelerate similarity searches and manage large volumes of inspection data).

In some implementations, Facebook AI Similarity Search (FAISS) may be used to create and index dense vector representations of images. FAISS is a high-performance library for similarity search and clustering of vectors that can build indices, perform nearest-neighbor queries, and optionally leverage GPUs to accelerate large-scale comparisons. In practice, vectors may be constructed from flattened pixel intensities, learned image embeddings, or feature descriptors, then inserted into a FAISS index (e.g., Flat, IVF, HNSW, or Product Quantization (PQ)) for efficient retrieval. In FAISS-based implementations, the vector database may be realized as one or more FAISS indices (e.g., IVF/Flat or IVFPQ) with trained coarse quantizers for fast routing of queries. Candidate image vectors may be probed against a limited set of index partitions (nprobe) to balance speed and accuracy, and GPU-backed indices may further reduce query latency.

Vectorization and similarity comparison may enable rapid processing of large datasets by transforming image comparison into fast linear-algebra operations and nearest-neighbor search over compact vectors. When combined with approximate nearest-neighbor indices (e.g., FAISS IVF/HNSW) and GPU acceleration, tens of thousands of images may be searched in near real time. Compared to deep learning inference pipelines, this approach may compute faster in various deployments because it does not require loading large model weights or executing multi-layer convolutional stacks. Instead, for example, the vectorization and similarity comparison approach can perform lightweight vector lookups and distance computations, which can be parallelized efficiently.

As discussed above, the value of N used to identify the N^{th} most similar reference image may be selected to be greater than the longest expected sequence of consecutive anomalous images. By doing so, the system can increase the likelihood that the N^{th} most similar reference image corresponds to a normal region of the object, rather than an anomalous region. In some implementations, selection of N may be based on empirical data, historical inspection results, or user-defined parameters, and can be adapted to different object types or inspection scenarios. Other automated strategies for selecting N may include estimating the spatial correlation length of anomalies from similarity-versus-position curves, applying change-point detection to similarity score sequences to infer typical anomaly run lengths, and/or modeling anomaly durations with Bayesian priors updated during inspection.

The processor circuit may generate a difference image between the candidate image and its N^{th} most similar reference image. The difference image may be generated by performing pixel subtraction between the candidate image and the N^{th} most similar reference image. Other suitable techniques for difference image generation may include absolute difference, squared-error maps, ratio images, gradient-difference maps, or frequency-domain differencing (e.g., subtracting magnitude spectra after FFT). Where alignment drift is present, the processor circuit may optionally perform image registration prior to differencing (e.g., phase correlation or feature-based registration) to reduce spurious artifacts.

The displayed indication of the anomaly may be based on the difference image, as the difference image can visually highlight regions of dissimilarity between an anomalous candidate image and a non-anomalous reference image. For example, areas of high pixel intensity in the difference image may correspond to defects or irregularities in the test object, allowing for intuitive visualization and assessment. The interface may display color-coded overlays (e.g., heatmaps with thresholded contours), bounding boxes around connected components, confidence-score badges, and/or tooltips with similarity metrics. In volumetric inspections, a 3D rendering or sectional slice viewer may be provided to scroll through layers of a composite difference image (e.g., discussed below), with synchronized cursors showing the candidate position and the position of the N^{th} most similar reference.

In some embodiments, the processor circuit may select each reference image of the object as the candidate image and identify an N^{th} most similar reference image for each candidate image. In this mode, all or substantially all of the reference images may be analyzed for anomalies by pairing each reference image with its Nth most similar image, computing a similarity score for the pair, and (e.g., when the score crosses the anomaly threshold) generating and storing a corresponding difference image and anomaly record (e.g., object position, similarity metric, threshold).

The processor circuit can generate a plurality of difference images from the determined image pairs. For example, each difference image may be generated from a respective candidate image and its corresponding N^{th} most similar reference image. A composite difference image for the object may be constructed from the plurality of difference images, providing a comprehensive visualization of anomalies across the entire object. This composite image may be presented as a heatmap, 3D rendering, or other graphical format to facilitate review. The interface may present the composite as a scrollable strip or tiled overview, allow toggling between raw and post-processed views, and/or provide synchronized crosshairs that link composite pixels to underlying candidate/reference image pairs. In some implementations, the composite may be overlaid on an object coordinate map or CAD geometry of the object to aid localization and remediation planning.

The processor circuit may post-process a difference image by applying any one or more of noise filtering, contrast enhancement, thresholding, or connected-component labeling. Noise filtering may reduce background artifacts by smoothing pixel values or removing high-frequency fluctuations. Contrast enhancement can improve visibility of defects by stretching or redistributing the intensity range. Thresholding may isolate regions of interest by converting the difference image into a binary mask, highlighting pixels that exceed a specified intensity and/or similarity threshold. Connected-component labeling can identify and count discrete anomalies by grouping contiguous regions in the thresholded image (e.g., enabling automated quantification and localization of defects). These post-processing steps may be performed individually or in combination, and may be adapted to the characteristics of the inspection data.

Reference images may be generated by processing the non-destructive test data using any one or more of normalization, smoothing, median filtering, or downsampling. Normalization may rescale pixel intensities (e.g., min–max or z-score normalization) to reduce variability caused by acquisition gain or coupling conditions and to make similarity scores comparable across positions. Smoothing may attenuate high-frequency noise using kernels such as Gaussian or bilateral filters, improving the stability of vectorization and subsequent comparisons. Median filtering may suppress impulse-like artifacts (e.g., speckle or outliers) by replacing each pixel with the median of its neighborhood (e.g., preserving edges better than linear smoothers). Downsampling may reduce image resolution or decimate data along one or more axes to decrease memory footprint and computation time (e.g., applicable for large-area scans while retaining sufficient detail for anomaly detection). These preprocessing techniques may be selected based on the type of NDT data and the desired analysis resolution.

The subset of remaining reference images used to determine the similarity scores may be selected to exclude reference images corresponding to positions within a determined positional proximity to the candidate image. This exclusion can reduce the likelihood of comparing positionally consecutive anomalous images, thereby improving the specificity of anomaly detection. The positional proximity threshold may be selected based on expected defect size, object geometry, or inspection protocol. Positions corresponding to images may be tracked or tagged in the image vector database (e.g., storing sequence indices, coordinates, or region IDs alongside each vector). During similarity search, the processor circuit may automatically filter out results whose positional tags fall within a user-defined window (e.g., ±k images or ±d millimeters). In alternative implementations, the processor circuit may weight similarity scores by a distance-dependent penalty, effectively suppressing near neighbors while retaining far-field matches.

Alternatively or additionally, the subset of remaining reference images used to determine the similarity scores may exclude reference images corresponding to positions outside a predetermined positional proximity of the candidate image. This constraint can focus the comparison on portions of the object having a common geometry or material properties, which may be particularly useful for objects with varying cross-sections or heterogeneous materials. The predetermined proximity may be defined by user input, automated analysis, or object design specifications. Positions may be organized using spatial indices (e.g., grids, quadtrees, or region labels), material/geometry tags (e.g., laminate stack, wall thickness), or segmentation maps derived from object models. The processor circuit may limit the searchable set to vectors whose tags match the candidate image’s region and/or fall within a specified spatial band. This filtering to a subset of positionally-proximate reference images for similarity comparison can ensure comparisons are made among images sharing common structural context. Automated routines may infer appropriate bands by analyzing similarity gradients across position or by referencing manufacturing drawings and tolerance specifications.

The system may be adapted for use with different types of NDT data, including one-dimensional (A-scan), two-dimensional (B-scan, C-scan, D-scan), or three-dimensional volumetric data. The probe assembly may be implemented as a hand-held device, a robotic scanner, or an integrated part of a larger inspection system. The processor circuit may be realized using on-board hardware, remote computing resources, or a combination thereof. The interface may support real-time or post-processing workflows, and may be integrated with data storage, traceability, and reporting systems.

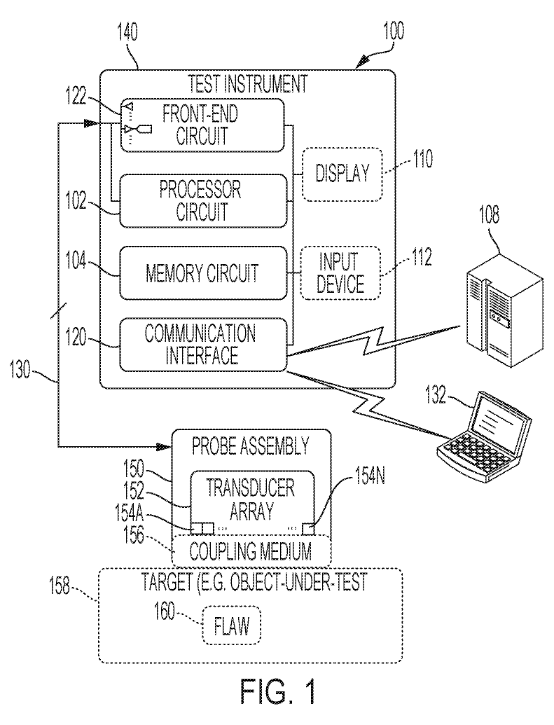

FIG. 1 illustrates generally an example comprising an acoustic (e.g., ultrasonic) inspection system 100, such as can be used to perform at least a portion one or more techniques as shown and described herein. The inspection system can include a test instrument 140, such as a hand-held or portable assembly. The test instrument can be electrically coupled to a probe assembly 150, such as using a multi-conductor interconnect 130. The probe assembly can include one or more electroacoustic transducers, such as a transducer array 152 including respective transducers 154A through 154N. The transducers array can follow a linear or curved contour or can include an array of elements extending in two axes, such as providing a matrix of transducer elements. The elements need not be square in footprint or arranged along a straight-line axis. Element size and pitch can be varied according to the inspection application.

A modular probe assembly configuration can be used, such as to allow a test instrument to be used with various different probe assemblies. Generally, the transducer array includes piezoelectric transducers, such as can be acoustically coupled to a target 158 (e.g., a test specimen or “object-under-test”) through a coupling medium 156. The coupling medium can include a fluid or gel or a solid membrane (e.g., an elastomer or other polymer material), or a combination of fluid, gel, or solid structures. For example, an acoustic transducer assembly can include a transducer array coupled to a wedge structure comprising a rigid thermoset polymer having known acoustic propagation characteristics (for example, Rexolite® available from C-Lec Plastics Inc.), and water can be injected between the wedge and the structure under test as a coupling medium during testing, or testing can be conducted with an interface between the probe assembly and the target otherwise immersed in a coupling medium.

The test instrument can include digital and analog circuitry, such as a front-end circuit 122 including one or more transmit signal chains, receive signal chains, or switching circuitry (e.g., transmit/receive switching circuitry). The transmit signal chain can include amplifier and filter circuitry, such as to provide transmit pulses for delivery through an interconnect to a probe assembly for insonification of the target, such as to image or otherwise detect a flaw 160 on or within the target structure by receiving scattered or reflected acoustic energy elicited in response to the insonification.

While FIG. 1 shows a single probe assembly and a single transducer array, other configurations can be used, such as multiple probe assemblies connected to a single test instrument, or multiple transducer arrays used with a single probe assembly or multiple probe assemblies for pitch/catch inspection modes. Similarly, a test protocol can be performed using coordination between multiple test instruments, such as in response to an overall test scheme established from a master test instrument or established by another remote system such as a compute facility 108 or general-purpose computing device such as a laptop 132, tablet, smart-phone, desktop computer, or the like. The test scheme may be established according to a published standard or regulatory requirement and may be performed upon initial fabrication or on a recurring basis for ongoing surveillance, as illustrative examples.

The receive signal chain of the front-end circuit can include one or more filters or amplifier circuits, along with an analog-to-digital conversion facility, such as to digitize echo signals received using the probe assembly. Digitization can be performed coherently, such as to provide multiple channels of digitized data aligned or referenced to each other in time or phase. The front-end circuit can be coupled to and controlled by one or more processor circuits, such as a processor circuit 102 included as a portion of the test instrument. The processor circuit can be coupled to a memory circuit, such as to execute instructions that cause the test instrument to perform one or more of acoustic transmission, acoustic acquisition, processing, or storage of data relating to an acoustic inspection, or to otherwise perform techniques as shown and described herein. The test instrument can be communicatively coupled to other portions of the system, such as using a wired or wireless communication interface 120.

For example, performance of one or more techniques as shown and described herein can be accomplished on-board the test instrument or using other processing or storage facilities such as using a compute facility or a general-purpose computing device such as a laptop, tablet, smart-phone, desktop computer, or the like. For example, processing tasks that would be undesirably slow if performed on-board the test instrument or beyond the capabilities of the test instrument can be performed remotely (e.g., on a separate system), such as in response to a request from the test instrument. Similarly, storage of imaging data or intermediate data such as A-scan matrices of time-series data or other representations of such data, for example, can be accomplished using remote facilities communicatively coupled to the test instrument. The test instrument can include a display 110, such as for presentation of configuration information or results, and an input device 112 such as including one or more of a keyboard, trackball, function keys or soft keys, mouse-interface, touch-screen, stylus, or the like, for receiving operator commands, configuration information, or responses to queries.

The inspection system may acquire non-destructive test data from the object-under-test using the probe assembly and test instrument. The probe assembly may scan across the object, collecting acoustic signals at a plurality of positions. These signals may be digitized and stored by the test instrument, and subsequently processed to generate reference images corresponding to each scanned position.

The processor circuit of the test instrument may analyze the acquired reference images to detect anomalies as described herein. For example, the processor circuit may generate vectorized representations of the reference images, compute similarity scores, and identify the N^{th} most similar reference image for each candidate image. The processor circuit may further generate difference images, apply post-processing techniques, and/or flag anomalies based on similarity thresholds. In some embodiments, the processor circuit may store and manage image data and analysis results in local memory (e.g., supporting real-time review and decision-making).

Additionally or alternatively, the inspection system may transmit acquired data to a remote system, such as the laptop, desktop computer, or the remote (e.g., cloud-based) compute facility, for further processing. The remote system may perform any or all of the anomaly detection functions described herein (e.g., vectorization, similarity analysis, difference image generation, and/or post-processing). This approach may be employed when processing large datasets, performing advanced analytics, and/or integrating with enterprise data management systems.

The display included in the test instrument, laptop, or remote system may present an interface for reviewing inspection results. The interface may display candidate images alongside visual markers, overlays, and/or annotations indicating detected anomalies. For example, the display may show difference images highlighting regions of dissimilarity, heatmaps representing anomaly scores, and/or composite visualizations summarizing anomalies across the object. The interface may provide interactive tools for navigating image data, adjusting analysis parameters, and/or exporting reports.

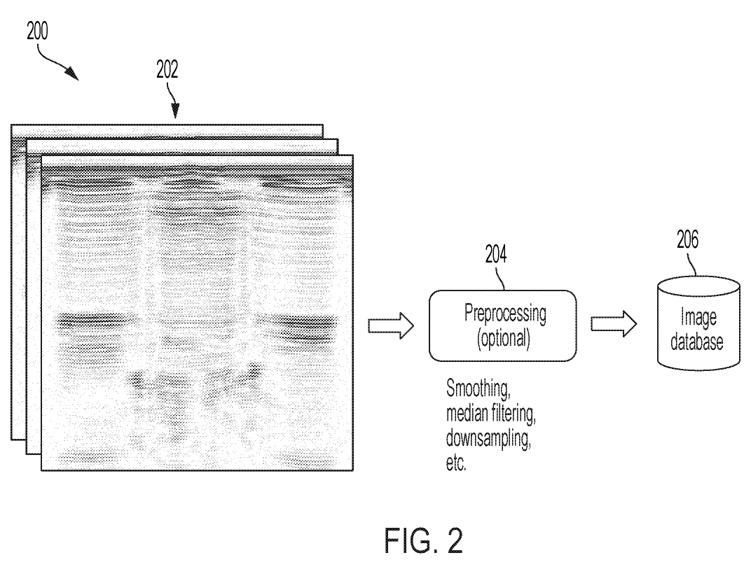

FIG. 2 illustrates a flowchart of an example method 200 for establishing a reference data set for use in anomaly detection of acoustic image data. The method of FIG. 2 may be performed by any embodiments of the systems and/or devices described herein.

A plurality of reference images 202 may be acquired and/or generated from non-destructive test data collected at a plurality of positions of an object. Acquisition may be performed by a probe assembly in cooperation with a test instrument, such as a hand-held or portable unit, or by a robotic scanner or other automated system. Reference images may be generated by processing raw acoustic signals (e.g., ultrasonic echo data) into image data representing the inspected regions of the object.

The method may optionally include preprocessing 204 of the reference images. Preprocessing may comprise one or more of smoothing, median filtering, or downsampling. Smoothing may be performed using techniques such as Gaussian or bilateral filtering to attenuate high-frequency noise and improve image stability. Median filtering may suppress impulse-like artifacts and preserve edges by replacing each pixel with the median value of its neighborhood. Downsampling may reduce the resolution of the images or decimate data along one or more axes, decreasing memory and computation requirements while retaining sufficient detail for anomaly detection. Preprocessing parameters may be selected based on the characteristics of the acoustic data and the desired analysis resolution.

An image database 206 is generated based on the reference images. The image database may be constructed by transforming each reference image into a vectorized representation, such as a feature vector comprising pixel intensities, statistical descriptors (e.g., means, variances, histograms), or learned embeddings (e.g., convolutional neural network features). The resulting vectors may be normalized to ensure consistent scaling and facilitate accurate similarity comparisons. The image database may be implemented using specialized indexing structures, such as KD-trees, approximate nearest neighbor algorithms, or other vector search libraries, to enable rapid retrieval and comparison of image vectors during anomaly detection.

In some embodiments, the image database 206 is generated on-the-fly while an object is being scanned. For example, as reference images are generated for the object, the processor circuit may vectorize the reference images and insert corresponding vectors into the image database 206. In this mode, the set of reference images being analyzed may be the same set used to form the image database 206, and the processor circuit may perform similarity search for a candidate image using vectors stored for other reference images in the image database 206. In such embodiments, a selected rank N used to identify an Nth reference image in a similarity ranking may be initialized to a predetermined value and may be adjusted during analysis based on inspection results or statistics collected from one or more scans.

In other embodiments, the image database 206 is generated offline using reference images identified as non-anomalous (e.g., known-good images) from one or more prior inspections. In such embodiments, when a new object is scanned, reference images generated for the new object may be analyzed as a dataset to be inspected, and similarity search for each candidate image in the dataset may be performed against the offline image database 206 comprising the known-good reference images. The processor circuit may identify, for a candidate image, one or more reference images in the image database 206 having highest similarity (or lowest distance) relative to the candidate image, including selecting a reference image at a selected rank N in a similarity ranking. In some embodiments, N may be set to 1 or another selected rank based on a desired comparison behavior or search configuration. In the offline known-good mode, the reference image may be the top-1 nearest neighbor, or an Nth neighbor.

In embodiments using an offline image database 206, variations in manufacturing processes, inspection setup, or acquisition conditions may cause a shift in similarity score distributions for non-anomalous images relative to the known-good reference images. In some embodiments, the processor circuit may record similarity scores or anomaly scores for inspected objects and may identify a condition indicative of a distribution shift, such as an increased count or proportion of candidate images meeting an anomaly criterion relative to a baseline. In response, the processor circuit may update the image database 206 by incorporating additional reference images determined to be non-anomalous under the updated conditions and/or by rebuilding or augmenting the index used by the image database 206.

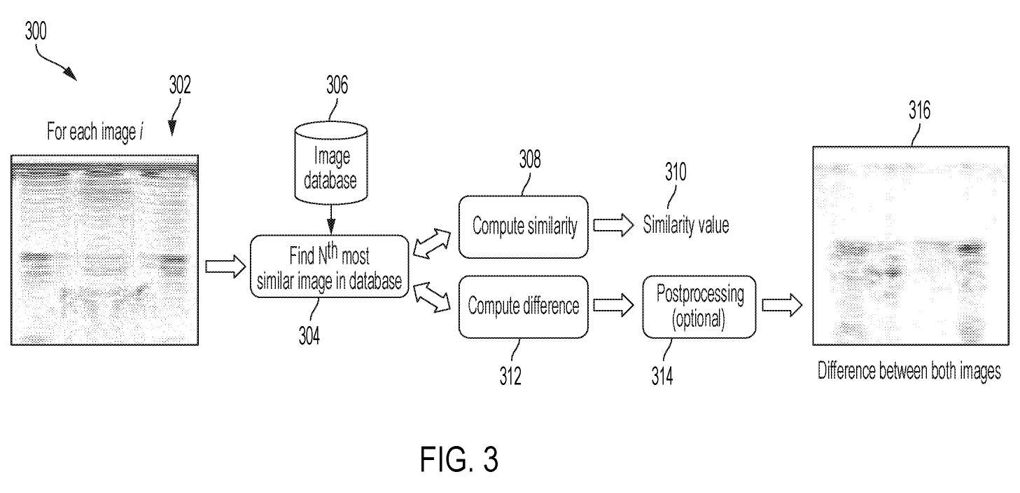

FIG. 3 illustrates a flowchart of an example method 300 for anomaly detection of acoustic image data. The method of FIG. 3 may be performed following and/or in coordination with the method of FIG. 2, for example by utilizing the image database generated by the method of FIG. 2 (e.g., an on-the-fly database generated for a scanned object or an offline database generated from known-good reference images). The method of FIG. 3 may be performed by any embodiments of the systems and/or devices described herein.

According to the method, a candidate image 302 (for example, an i^{th} image from the plurality of reference images) is selected for analysis. Selection may be automated, such as by iterating through all images in the image database, or user-directed, such as by focusing on a region of interest.

The N^{th} most similar image to the candidate image is found 304 by searching an image database 306 (e.g., the image database generated by the method of FIG. 2). The Nth most similar image may be identified by searching the image database and computing 308 a similarity between the candidate image and at least a subset of the reference images represented in the image database.

A resulting similarity value 310 may be generated for each similarity comparison between the candidate image and the reference images. Similarity values may be computed using vector distance metrics, such as Euclidean distance, cosine similarity, or dot product, based on vectorized representations of the images in the image database. In some implementations, if the similarity value satisfies a threshold (e.g., falls below or above a predetermined value indicating sufficient dissimilarity, depending on the metric), then the candidate image may be flagged as including an anomaly.

The method may further include computing 312 a difference image 316 between the candidate image and the N^{th} most similar reference image. The difference image may be computed by performing pixel subtraction between the candidate image and the N^{th} most similar reference image. The difference image can visually highlight regions of dissimilarity between the candidate image and the N^{th} most similar reference image (e.g., which may correspond to defects or irregularities in the test object).

Optionally, the initially computed difference image may be postprocessed 314. Postprocessing may include noise filtering (e.g., smoothing or suppressing high-frequency fluctuations), contrast enhancement (e.g., redistributing or stretching intensity ranges to make subtle anomalies more visible), thresholding (e.g., isolating regions of interest by generating a binary mask for pixels above a selected criterion), and/or connected-component labeling (e.g., identifying and counting discrete anomaly regions for automated quantification and localization).

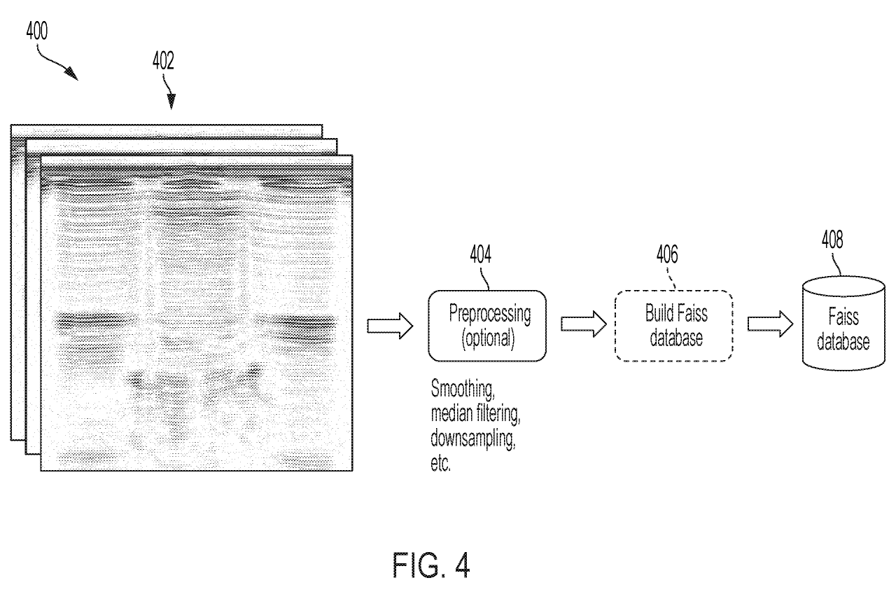

FIG. 4 illustrates a flowchart of an example method 400 for establishing a reference data set for use in anomaly detection of acoustic image data. The method of FIG. 4 may be employed as an example implementation of the method of FIG. 2.

A plurality of reference images may be acquired and/or generated from non-destructive test data collected at a plurality of positions of an object, as described above. The method may optionally include preprocessing 404 of the reference images, such as smoothing, median filtering, or downsampling, to enhance image quality and reduce noise (e.g., similar to the method of FIG. 2).

The method further includes building 406 a FAISS database 408 based on the reference images. Building a FAISS database may involve transforming each reference image into a dense vector representation, such as by flattening pixel intensities, extracting statistical features, or computing learned embeddings. The vectors may be normalized and inserted into a FAISS index, which may be configured as a Flat index (brute-force search), an Inverted File (IVF) index (coarse quantization and partitioning), a Hierarchical Navigable Small World (HNSW) graph (efficient graph-based search), or a Product Quantization (PQ) index (compressed vector storage).

To build the FAISS database, a training phase may be performed to learn quantization parameters or partition boundaries, depending on the index type. For example, in an IVF index, a k-means clustering algorithm may be used to partition the vector space into coarse clusters, and each reference image vector is assigned to the nearest cluster. The database may be further optimized for speed and scalability by leveraging GPU acceleration, batch insertion, and/or multi-threaded search capabilities. Once constructed, the FAISS database can enable rapid nearest-neighbor queries, allowing efficient comparison of candidate images to the reference set and identification of anomalies based on similarity scores.

The FAISS database may be stored locally on the test instrument, on a laptop or desktop computer, or on a remote compute facility. The FAISS database may be integrated with other data management systems to support real-time or batch anomaly detection workflows.

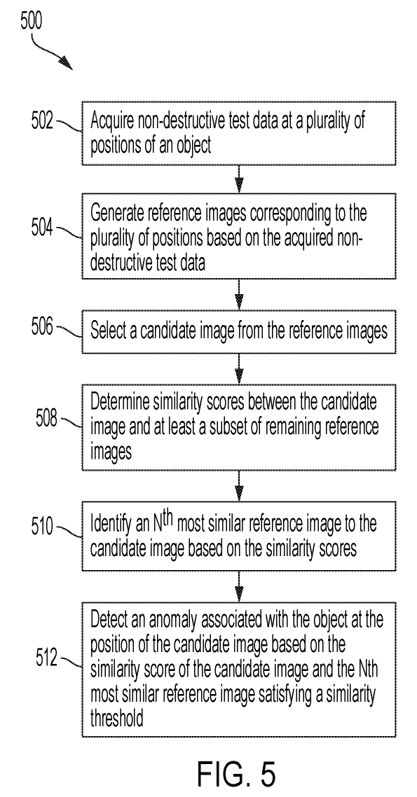

FIG. 5 illustrates an example method 500 for detecting anomalies in non-destructive test data. The method of FIG. 5 may be performed by any embodiments of the systems and/or device described herein.

According to the method, non-destructive test data is acquired 502 at a plurality of positions of an object. Acquisition may be performed, for example, by a probe assembly in cooperation with a test instrument, such as a hand-held or portable unit. Reference images corresponding to the plurality of positions are generated 504 based on the acquired non-destructive test data. Reference image generation may be executed a processor circuit of the test instrument, by a laptop or desktop computer, and/or by a remote compute facility, any of which may process raw signals to construct image data for each position.

According to the method, a candidate image is selected 506 from the reference images for further analysis. Selection of the candidate image may be automated, for example by iterating through all images, or user-directed, for example by selecting a region of interest. Similarity scores are determined 508 between the candidate image and at least a subset of remaining reference images. Similarity computation may be performed by the processor circuit of the test instrument and/or by remote system (e.g., when larger datasets or accelerated hardware are preferred). An N^{th} most similar reference image to the candidate image is identified 510 based on the similarity scores. The value of N may be chosen to avoid consecutive anomalous regions (e.g., as discussed further herein). An anomaly associated with the object may be detected 512 at the position of the candidate image, for example when the similarity score between the candidate image and the N^{th} most similar reference image satisfies a similarity threshold. Detected anomalies may be flagged for visualization and review.

According to some embodiments, the method may include generating vectorized representations of the reference images for comparison in an embedding space, and determining the similarity scores using a vector distance or a dot product. For example, each image may be transformed into a feature vector by flattening pixel intensities, extracting statistical descriptors such as means, variances, or histograms, or computing learned embeddings such as convolutional neural network features. Vectors may be normalized and compared using Euclidean distance, cosine or dot product, or other metrics. Vectorization may be performed locally on the test instrument or off-device by a remote server at a compute facility to leverage specialized hardware.

According to some embodiments, N may be greater than the longest expected sequence of consecutive anomalous images so that the N^{th} most similar reference image corresponds to a non-anomalous region. N may be set by user policy, historical inspection data, or adaptively estimated during a run, for example by analyzing similarity versus position curves, using change-point detection on similarity sequences, or applying Bayesian priors on typical anomaly lengths.

According to some embodiments, the method may include generating a difference image via pixel subtraction between the candidate image and the N^{th} most similar reference image, and displaying an indication of the anomaly based on the difference image. In practice, the difference image may be shown with color-coded overlays, thresholded contours, or heatmaps. A display on the test instrument, on a laptop, or via a remote viewer may present the candidate image and/or the difference visualization and associated similarity metrics to guide review.

According to some embodiments, the method may include post-processing the difference image by applying any one or more of noise filtering, contrast enhancement, thresholding, or connected-component labeling. Noise filtering may reduce background artifacts by smoothing or suppressing high-frequency fluctuations. Contrast enhancement may redistribute or stretch intensity ranges to make subtle anomalies more visible. Thresholding may isolate regions of interest by generating a binary mask for pixels above a selected criterion. Connected-component labeling may identify and count discrete anomaly regions for automated quantification and localization. Post-processing may occur on the instrument or off-device.

According to some embodiments, generating the reference images may include constructing image data from the non-destructive test signals and then processing the image data via normalization, smoothing, median filtering, or downsampling. Normalization may rescale intensities to reduce variability from gain or coupling conditions. Smoothing, such as Gaussian or bilateral filtering, may attenuate noise for more stable comparisons. Median filtering may suppress impulse-like artifacts while preserving edges. Downsampling may reduce resolution or decimate data to lower memory and computation requirements while retaining sufficient detail for anomaly detection.

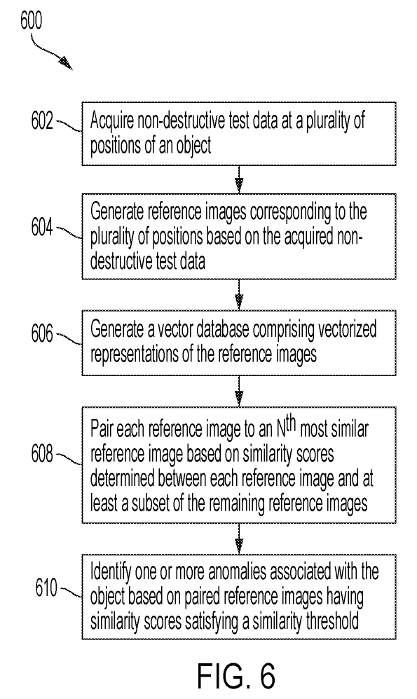

According to some embodiments, the subset of reference images used to determine similarity may exclude images corresponding to positions within a determined positional proximity to the candidate image (e.g., as plus or minus k images or plus or minus d millimeters). Positions may be tracked as tags, such as sequence index, coordinates, or region IDs, stored with each image or vector. As used herein, a similarity search may include querying an image database or vector database using a candidate image (or a vectorized representation of the candidate image) to retrieve one or more reference images ranked according to similarity scores (e.g., highest similarity or lowest distance, depending on the metric), such as to identify an Nth reference image in a similarity ranking. During the similarity search, the method may filter out results whose tags fall within the proximity window. In the methods of FIG. 5 and FIG. 6, the similarity search may correspond to the operations that determine similarity scores and identify the N^{th} reference image for comparison or pairing.

According to some embodiments, the subset of reference images used to determine similarity may exclude images corresponding to positions outside a predetermined positional proximity of the candidate image, thereby constraining comparisons to portions of the object having common geometry or material properties. Positions may be organized by spatial indices such as grids or bands, geometry or material tags such as laminate stack or wall thickness, or segmentation maps derived from object models. The searchable set may be limited to images whose tags match the candidate region, ensuring comparisons reflect similar structural context.

FIG. 6 illustrates an example method 600 for detecting anomalies in non-destructive test data. The method of FIG. 6 may be performed by any embodiments of the systems and/or devices described herein.

According to the method, non-destructive test data is acquired 602 at a plurality of positions of an object. Acquisition may be performed, for example, by a probe assembly in cooperation with a test instrument, such as a hand-held or portable unit. Reference images corresponding to the plurality of positions are generated 604 based on the acquired non-destructive test data. Reference image generation may be executed by a processor circuit of the test instrument, by a laptop or desktop computer, and/or by a remote compute facility, any of which may process raw signals to construct image data for each position. A vector database is generated 606 comprising vectorized representations of the reference images. For example, each reference image may be transformed into a feature vector by flattening pixel intensities, extracting statistical descriptors such as means, variances, or histograms, or computing learned embeddings such as convolutional neural network features. The vector database may be implemented using specialized indexing structures, such as KD-trees, approximate nearest neighbor algorithms, or FAISS indices, to facilitate rapid retrieval and comparison of image vectors.

According to the method, each reference image is paired 608 to an N^{th} most similar reference image based on similarity scores determined between each reference image and at least a subset of the remaining reference images. Similarity scores may be determined using a vector distance metric, such as Euclidean distance, or by computing a dot product between vectors. The value of N may be chosen to avoid consecutive anomalous regions, as discussed further herein. In some embodiments, the similarity score for each paired reference image may be treated as an anomaly score for the corresponding reference image, and the processor circuit may evaluate the anomaly score relative to an anomaly criterion defined by the similarity threshold. The processor circuit may apply the anomaly criterion across a plurality of paired reference images to generate a set of anomaly indications, for example by flagging reference images whose similarity scores meet the anomaly criterion and optionally storing an associated position index, score value, and reference-image identifier. For example, if the similarity score between a reference image and its Nth most similar reference image falls below or above a predetermined threshold, the reference image may be flagged as anomalous. Detected anomalies may be recorded for visualization and review.

According to some embodiments, the method may include generating a plurality of difference images via pixel subtraction based on a determined difference between each of the paired reference images. For example, each difference image may be generated from a respective reference image and its corresponding Nth most similar reference image. Other suitable techniques for difference image generation may include absolute difference, squared-error maps, ratio images, gradient-difference maps, or frequency-domain differencing.

According to some embodiments, a composite difference image for the object may be constructed from the plurality of difference images, providing a comprehensive visualization of anomalies across the entire object. The composite image may be presented as a heatmap, 3D rendering, or other graphical format to facilitate review. The interface may present the composite as a scrollable strip or tiled overview, allow toggling between raw and post-processed views, and/or provide synchronized crosshairs that link composite pixels to underlying image pairs. In some implementations, the composite may be overlaid on an object coordinate map or CAD geometry of the object to aid localization and remediation planning.

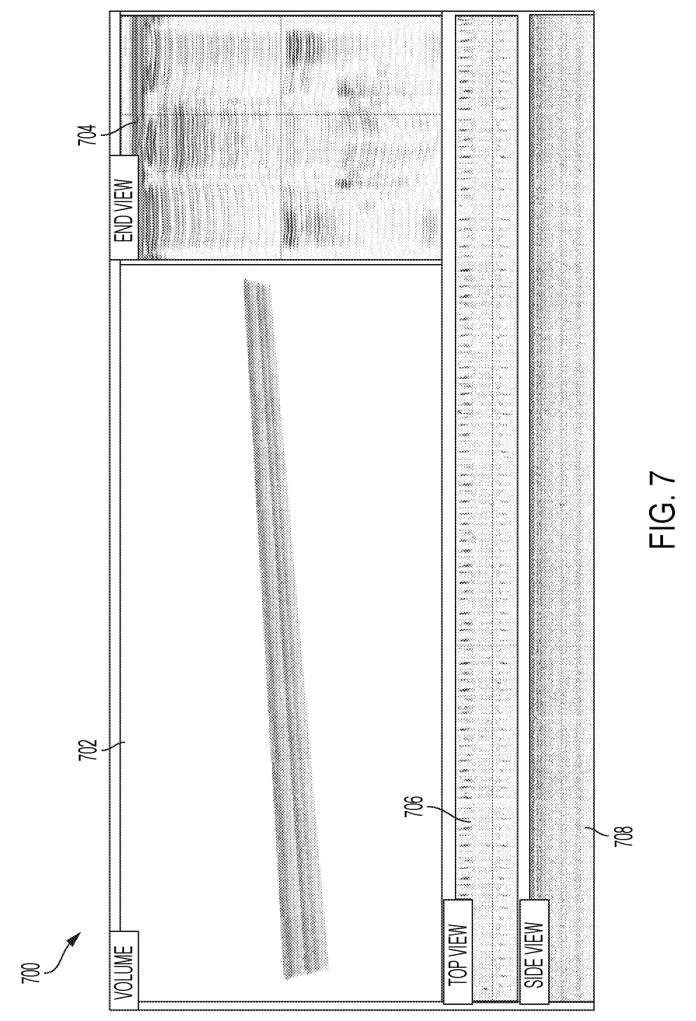

FIG. 7 is a user interface 700 displaying different views of an example composite image based on simulated acoustic data of a wind blade. The composite image is created from over ten thousand individual reference images acquired during inspection of the wind turbine blade. The user interface may present a volumetric view 702 (e.g., a 3D rendering of the entire scanned volume), an end view 704 (showing a cross-sectional slice from the end of the blade), a top view 706 (displaying the blade from above), and a side view 708 (displaying the blade from the side). In any of these views, anomalies detected according to the methods described herein may be flagged or otherwise identified in the user interface. For example, regions corresponding to detected anomalies may be highlighted with color overlays, bounding boxes, or other visual markers, enabling inspectors to quickly locate and assess areas of concern within the composite image.

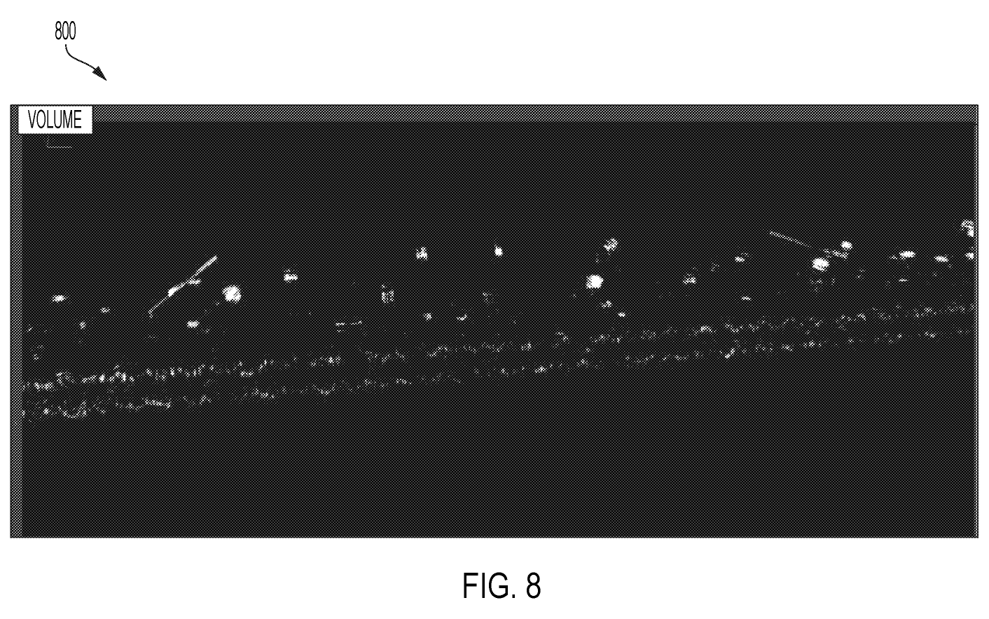

FIG. 8 is an example difference image 800 based on the composite image of FIG. 7, shown in volumetric view. The difference image was created by identifying the N^{th} most similar image for each of the thousands of reference images in the composite, then subtracting each reference image from its paired N^{th} most similar image. The resulting difference images were combined to form a composite difference image that visually highlights regions of dissimilarity across the entire scanned volume. In the volumetric view, brighter spots in the difference image correspond to locations where the differences between paired images are greater, indicating potential anomalies or defects in the wind turbine blade. These bright regions may be flagged for further review or automated analysis.

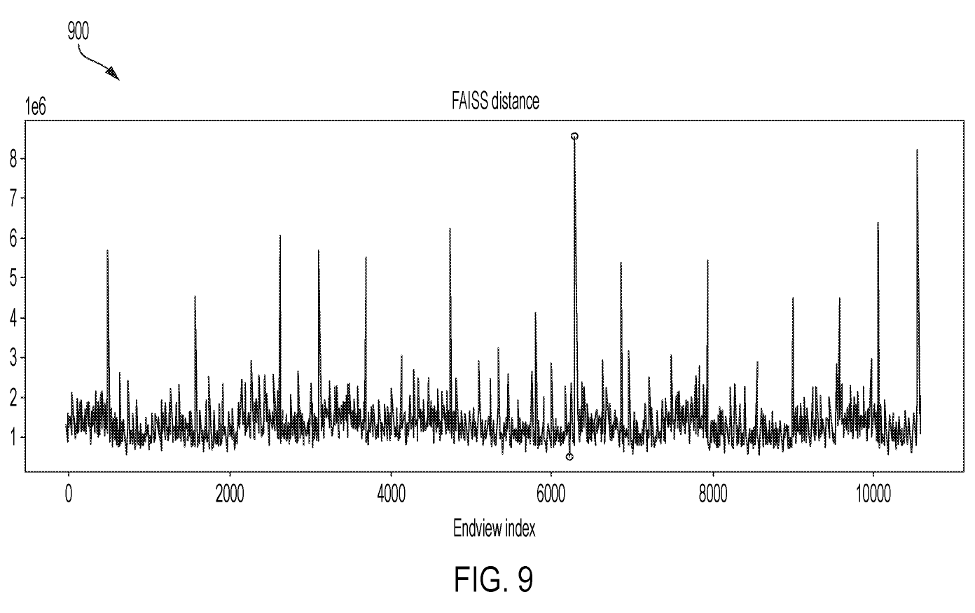

FIG. 9 is an example similarity plot 900 corresponding to the end view composite image of FIG. 7. The similarity plot was generated by calculating the FAISS distance between each reference image and its N^{th} most similar image, with the results plotted along the end view index (e.g., position along the blade cross-section). Spikes in the FAISS distance indicate that the corresponding reference image is more dissimilar from its paired N^{th} most similar image compared to other pairs. In some implementations, the similarity plot may be generated using simulated or synthetic reference images, and the baseline FAISS distance may vary across the index (e.g., where synthetic images are generated to be distinct from one another). In such cases, anomaly identification may be based on a threshold selected relative to the score distribution for the dataset and/or based on deviation from a local baseline, such that the threshold is not assumed to correspond to a flat baseline distance. Where the baseline distance is elevated or non-flat, a higher or adaptive threshold may be used to reduce false positives. Thus, indexed images corresponding to spiked FAISS distance values are likely to include anomalies, such as defects or data quality issues, at the corresponding positions on the test object. The similarity plot provides a quantitative visualization that can be used to quickly identify regions of interest for further inspection or validation.

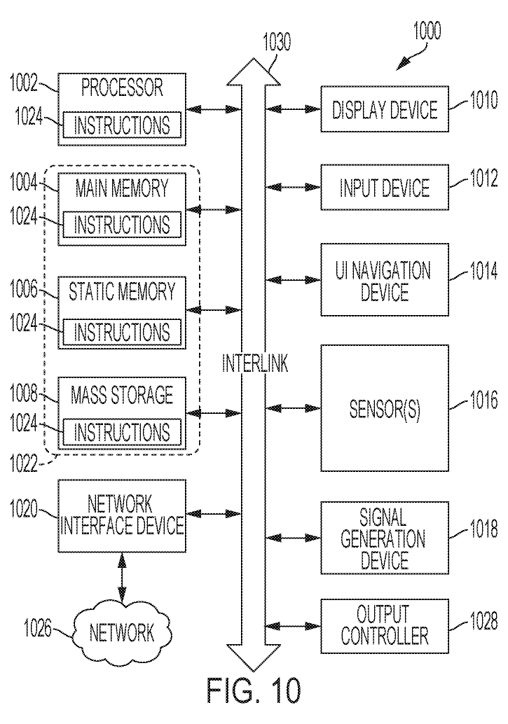

FIG. 10 illustrates a block diagram of an example comprising a machine 1000 upon which any one or more of the techniques (e.g., methodologies) discussed herein may be performed. The machine (e.g., computer system) may include a hardware processor 1002 (e.g., a central processing unit (CPU), a graphics processing unit (GPU), a hardware processor core, or any combination thereof), a main memory 1004 and a static memory 1006, connected via an interlink 1030 (e.g., link or bus), as some or all of these components may constitute hardware for systems or related implementations discussed above.

Generally, the hardware processor may, for example, include at least one of a Central Processing Unit (CPU), a Reduced Instruction Set Computing (RISC) Processor, a Complex Instruction Set Computing (CISC) Processor, a Graphics Processing Unit (GPU), a Digital Signal Processor (DSP), a Tensor Processing Unit (TPU), a Neural Processing Unit (NPU), a Vision Processing Unit (VPU), a Machine Learning Accelerator, an Artificial Intelligence Accelerator, an Application Specific Integrated Circuit (ASIC), a Field Programmable Gate Array (FPGA), a Radio-Frequency Integrated Circuit (RFIC), a Neuromorphic Processor, a Quantum Processor, or any combination thereof. A processor circuit may further be a multi-core processor having two or more independent processors (sometimes referred to as "cores") that may execute instructions contemporaneously. Multi-core processors contain multiple computational cores on a single integrated circuit die, each of which can independently execute program instructions in parallel. Parallel processing on multi-core processors may be implemented via architectures like superscalar, VLIW, vector processing, or SIMD that allow each core to run separate instruction streams concurrently. A processor circuit may be emulated in software, running on a physical processor, as a virtual processor or virtual circuit. The virtual processor may behave like an independent processor but is implemented in software rather than hardware.

Specific examples of main memory include Random Access Memory (RAM), and semiconductor memory devices, which may include storage locations in semiconductors such as registers. Specific examples of static memory include non-volatile memory, such as semiconductor memory devices (e.g., Electrically Programmable Read-Only Memory (EPROM), Electrically Erasable Programmable Read-Only Memory (EEPROM)) and flash memory devices; magnetic disks, such as internal hard disks and removable disks; magneto-optical disks; RAM; or optical media such as CD-ROM and DVD-ROM disks.

The machine may further include a display device 1010, an input device 1012 (e.g., a keyboard), and a user interface (UI) navigation device 1014 (e.g., a mouse). In an example, the display device, input device, and UI navigation device may be a touch-screen display. The machine may include a mass storage device 1008 (e.g., drive unit), a signal generation device 918 (e.g., a speaker), a network interface device 1020, and one or more sensors 1016, such as a global positioning system (GPS) sensor, compass, accelerometer, or some other sensor. The machine may include an output controller 1028, such as a serial (e.g., universal serial bus (USB), parallel, or other wired or wireless (e.g., infrared (IR), near field communication (NFC), etc.) connection to communicate or control one or more peripheral devices (e.g., a printer, card reader, etc.).

The mass storage device may comprise a machine-readable medium 1022 on which is stored one or more sets of data structures or instructions 1024 (e.g., software) embodying or utilized by any one or more of the techniques or functions described herein. The instructions may also reside, completely or at least partially, within the main memory, within static memory, or within the hardware processor during execution thereof by the machine. In an example, one or any combination of the hardware processor, the main memory, the static memory, or the mass storage device comprises a machine readable medium.

In one embodiment, a system for detecting anomalies in non-destructive test data includes: a probe assembly configured to acquire non-destructive test data at a plurality of positions on an object; and a processor circuit communicatively coupled to the probe assembly, the processor circuit configured to: generate reference images corresponding to the plurality of positions based on the acquired non-destructive test data; select a candidate image from among the reference images, the candidate image associated with a position from the plurality of positions; determine similarity scores between the candidate image and at least a subset of the remaining reference images; identify, based on the similarity scores, a reference image from among the at least a subset of the remaining reference images for comparison with the candidate image; and detect an anomaly associated with the object at the position associated with the candidate image utilizing (i) a similarity threshold and (ii) a similarity score of the candidate image and the reference image.

In any of the embodiments of the system for detecting anomalies in non-destructive test data, the processor circuit may be configured to: rank the reference images in a similarity ranking based on the similarity scores; and select an Nth reference image in the similarity ranking to identify as the reference image, wherein N is a selected rank. Additionally, or alternatively, the processor circuit may be configured to generate vectorized representations of the reference images for comparison in an embedding space, and the similarity scores are determined using a vector distance or dot product, wherein the processor circuit is configured to store the vectorized representations of the reference images in an image vector database. Additionally, or alternatively, the reference image may be an Nth reference image in a similarity ranking of the at least a subset of the remaining reference images, and wherein N is greater than a longest expected sequence of consecutive anomalous images such that the Nth reference image corresponds to a non-anomalous region of the object. Additionally, or alternatively, the system may include an interface configured to display the candidate image with an indication of the anomaly, wherein the processor circuit is configured to generate a difference image via pixel subtraction using the candidate image and the Nth reference image, and the displayed indication of the anomaly is based on the difference image. Additionally, or alternatively, the processor circuit may be configured to: generate a plurality of difference images, each difference image based on a respective candidate image and its corresponding Nth reference image; and construct a composite difference image for the object from the plurality of difference images to visualize anomalies. Additionally, or alternatively, the processor circuit may be configured to post-process the difference image by applying any one or more of noise filtering, contrast enhancement, thresholding, or connected-component labeling. Additionally, or alternatively, the processor circuit may be configured to generate the reference images by generating image data based on the non-destructive test data and processing the image data via any one or more of normalization, smoothing, median filtering, or downsampling. Additionally, or alternatively, the at least a subset of the remaining reference images may be used to determine the similarity scores excludes at least one of: one or more reference images corresponding to positions within a determined positional proximity to the candidate image to reduce a similarity comparison of positionally consecutive anomalous images; or one or more reference images corresponding to positions outside a determined positional proximity of the candidate image to constrain comparison to portions of the object having a common geometry or common material properties. Additionally, or alternatively, to detect the anomaly, the processor circuit may be configured to compare the similarity score between the candidate image and the identified reference image to the similarity threshold.

In one embodiment, a method for detecting anomalies in non-destructive test data includes: acquiring non-destructive test data at a plurality of positions on an object; generating reference images corresponding to the plurality of positions based on the acquired non-destructive test data; selecting a candidate image from the reference images, the candidate image associated with a position from the plurality of positions; determining similarity scores between the candidate image and at least a subset of remaining reference images; identifying, based on the similarity scores, a reference image to the candidate image from the at least a subset of remaining reference images; and detecting an anomaly associated with the object at the position of the candidate image utilizing (i) a similarity threshold and (ii) a similarity score of the candidate image and the reference image.

In any of the embodiments of the method for detecting anomalies in non-destructive test data, identifying the reference image may include: ranking the reference images in a similarity ranking based on the similarity scores; and selecting an Nth reference image in the similarity ranking to identify as the reference image, wherein N is a selected rank. Additionally, or alternatively, the reference image may be an Nth reference image in a similarity ranking of the at least a subset of the remaining reference images, and wherein N is greater than a longest expected sequence of consecutive anomalous images such that the Nth reference image corresponds to a non-anomalous region of the object. Additionally, or alternatively, the method may include selecting an Nth reference image in a similarity ranking of the at least a subset of the remaining reference images to identify as the reference image, wherein N is a selected rank; generating a difference image via pixel subtraction using the candidate image and the Nth reference image; and displaying an indication of the anomaly based on the difference image. Additionally, or alternatively, the method may include post-processing the difference image by applying any one or more of noise filtering, contrast enhancement, thresholding, or connected-component labeling. Additionally, or alternatively, generating the reference images may include: generating image data based on the non-destructive test data; and processing the image data via any one or more of normalization, smoothing, median filtering, or downsampling. Additionally, or alternatively, the at least a subset of the remaining reference images may be used to determine the similarity scores excludes reference images corresponding to positions within a determined positional proximity to the candidate image. Additionally, or alternatively, the at least a subset of the remaining reference images may be used to determine the similarity scores excludes reference images corresponding to positions outside a determined positional proximity of the candidate image to constrain comparison to portions of the object having a common geometry or material properties.

In one embodiment, a method for detecting anomalies in non-destructive test data includes: acquiring non-destructive test data at a plurality of positions on object; generating reference images corresponding to the plurality of positions based on the acquired non-destructive test data; generating a vector database comprising vectorized representations of the reference images; pairing each reference image to an Nth reference image based on similarity scores determined between each reference image and at least a subset of the remaining reference images, wherein N is a selected rank in a similarity ranking of the reference images; and identifying one or more anomalies associated with the object based on paired reference images having similarity scores and based on a similarity threshold.

In any of the embodiments of the method for detecting anomalies in non-destructive test data, the method may include generating a plurality of difference images via pixel subtraction based on a determined difference between each of the paired reference images; and constructing a composite difference image for the object from the plurality of difference images to visualize the one or more anomalies.

Specific examples of machine-readable media include, one or more of non-volatile memory, such as semiconductor memory devices (e.g., EPROM or EEPROM) and flash memory devices; magnetic disks, such as internal hard disks and removable disks; magneto-optical disks; RAM; or optical media such as CD-ROM and DVD-ROM disks. While the machine-readable medium is illustrated as a single medium, the term "machine readable medium" may include a single medium or multiple media (e.g., a centralized or distributed database, or associated caches and servers) configured to store the one or more instructions.

An apparatus of the machine includes one or more of a hardware processor (e.g., a central processing unit (CPU), a graphics processing unit (GPU), a hardware processor core, or any combination thereof), a main memory and a static memory, sensors, network interface device, antennas, a display device, an input device, a UI navigation device, a mass storage device, instructions, a signal generation device, or an output controller. The apparatus may be configured to perform one or more of the methods or operations disclosed herein.

The term “machine readable medium” includes, for example, any medium that is capable of storing, encoding, or carrying instructions for execution by the machine and that cause the machine to perform any one or more of the techniques of the present disclosure or causes another apparatus or system to perform any one or more of the techniques, or that is capable of storing, encoding or carrying data structures used by or associated with such instructions. Non-limiting machine-readable medium examples include solid-state memories, optical media, or magnetic media. Specific examples of machine-readable media include: non-volatile memory, such as semiconductor memory devices (e.g., Electrically Programmable Read-Only Memory (EPROM), Electrically Erasable Programmable Read-Only Memory (EEPROM)) and flash memory devices; magnetic disks, such as internal hard disks and removable disks; magneto-optical disks; Random Access Memory (RAM); or optical media such as CD-ROM and DVD-ROM disks. In some examples, machine readable media includes non-transitory machine-readable media. In some examples, machine readable media includes machine readable media that is not a transitory propagating signal.

The instructions may be transmitted or received, for example, over a communications network using a transmission medium via the network interface device utilizing any one of a number of transfer protocols (e.g., frame relay, internet protocol (IP), transmission control protocol (TCP), user datagram protocol (UDP), hypertext transfer protocol (HTTP), etc.). Example communication networks include a local area network (LAN), a wide area network (WAN), a packet data network (e.g., the Internet), mobile telephone networks (e.g., cellular networks), Plain Old Telephone (POTS) networks, and wireless data networks (e.g., Institute of Electrical and Electronics Engineers (IEEE) 802.11 family of standards known as Wi-Fi®), IEEE 802.15.4 family of standards, a Long Term Evolution (LTE) 4G or 5G family of standards, a Universal Mobile Telecommunications System (UMTS) family of standards, peer-to-peer (P2P) networks, satellite communication networks, among others.

In an example, the network interface device includes one or more physical jacks (e.g., Ethernet, coaxial, or other interconnection) or one or more antennas to access the communications network. In an example, the network interface device includes one or more antennas to wirelessly communicate using at least one of single-input multiple-output (SIMO), multiple-input multiple-output (MIMO), or multiple-input single-output (MISO) techniques. In some examples, the network interface device wirelessly communicates using Multiple User MIMO techniques. The term “transmission medium” shall be taken to include any intangible medium that is capable of storing, encoding or carrying instructions for execution by the machine, and includes digital or analog communications signals or other intangible medium to facilitate communication of such software.

The terms “processor circuit,” “control circuit,” and “controller” are substitutable with each other and encompasses hardwired circuitry, programmable logic (such as microprocessors, microcontrollers, digital signal processors (DSPs), programmable logic devices (PLDs), programmable gate arrays (PGAs), or field-programmable gate arrays (FPGAs)), state machines, or firmware that executes stored instructions. Processor circuits may form part of larger systems, such as integrated circuits (ICs), application-specific integrated circuits (ASICs), or systems-on-chips (SoCs), and may be found in devices such as computers, smartphones, wearable devices, and servers. These circuits may perform tasks involving data processing, communication, or data storage. Depicted components, functions, or operations may be implemented using hardware, software, firmware, or combinations of two or more thereof.

Instructions for implementing system features may be stored in various types of memory. Suitable memory may include dynamic random-access memory (DRAM), flash memory, and/or cache. These instructions may be distributed over a network or via other computer-readable media. The term "non-transitory computer-readable medium" refers to any physical medium capable of storing or transmitting instructions or information that may be read by a machine. Examples of suitable media include RAM, ROM, EPROM, EEPROM, magnetic or optical media, flash memory, or even propagated signals such as carrier waves or infrared signals.

In some embodiments, the processor circuit may utilize machine learning (ML) techniques to make decisions based on sensor inputs or other data. Suitable ML methods may include supervised learning (with labeled inputs and outputs), unsupervised learning (for identifying patterns), or reinforcement learning (where the system adapts based on feedback). Suitable tasks for ML systems may involve classification, regression, clustering, anomaly detection, or optimization. ML may employ algorithms, such as decision trees, deep learning, support vector machines (SVMs), or neural networks, depending on the application. A suitable processor circut may incorporate a policy engine that applies specific rules based on equipment characteristics or environmental conditions. For instance, a neural network could process sensor data or operational inputs to determine appropriate actions. Techniques such as backpropagation or evolutionary strategies may be used to refine neural network parameters and optimize model selection for the given task.

In one embodiment, the processor circuit (or controller) and system described herein may use machine learning to make determinations and to enable derivation-based learning outcomes. The system may communicate with a data collection system. The processor circuit may learn from, model and make decisions/determinations on a set of data (including data provided by various sensors and data collection systems) by making data-driven predictions and adapting according to available data and modeling.

Machine learning may involve performing tasks using supervised learning, unsupervised learning, and reinforcement learning systems. Supervised learning may use a set of example inputs and desired outputs to the machine learning systems, where unsupervised learning may use a learning algorithm that is structuring its input with, e.g., pattern detection and/or feature learning. Reinforcement learning may perform in a dynamic environment and then provide feedback about correct and incorrect decisions. Machine learning may include tasks based on certain outputs. These tasks may be machine learning problems such as classification, regression, clustering, density estimation, dimensionality reduction, anomaly detection, and the like to include other mathematical and statistical techniques.

Suitable machine learning algorithmic types may include decision tree based learning, association rule learning, deep learning, artificial neural networks, genetic learning algorithms, inductive logic programming, support vector machines (SVMs), Bayesian network, reinforcement learning, representation learning, rule-based machine learning, sparse dictionary learning, similarity and metric learning, learning classifier systems (LCS), logistic regression, random forest, K-Means, gradient boost, K-nearest neighbors (KNN), a priori algorithms, and the like. In embodiments, certain machine learning algorithms may be used (e.g., for solving both constrained and unconstrained optimization problems that may be based on natural selection). In an example, the algorithm may be used to address problems of mixed integer programming, where some components restricted to being integer-valued. Algorithms and machine learning techniques and systems may be used in computational intelligence systems, computer vision, Natural Language Processing (NLP), recommender systems, reinforcement learning, building graphical models, and the like. In an example, machine learning may be used for making determinations, calculations, comparisons and behavior analytics, and the like.

As mentioned above, the processor circuit may include a policy engine. The policies the engine may apply may be based at least in part on characteristics of a given item of equipment or environment. For example, an artificial intelligence system, such as a neural network, may receive input of a number of environmental and task-related parameters. These parameters may include, for example, operational input of the given equipment, data from various sensors, environmental information, location and/or position data, and the like. The neural network may be trained and may generate an output based on these inputs, with the output representing an action or sequence of actions that the equipment or system should take to accomplish the goal of the operation. The processor circuit may process the inputs through the parameters of the neural network to generate a value (e.g., make a determination) at the output node designating that action as the desired action, activity, or operating state. An action may translate into a signal that causes the vehicle to operate in a particular manner. The processor circuit may accomplish this via back-propagation, feed forward processes, closed loop feedback, or open loop feedback, for example. Alternatively, rather than using backpropagation, the processor circuit may use evolution strategies techniques to tune various parameters of the neural network. The processor circuit may use neural network architectures that have a set of parameters representing weights of its node connections. A number of copies of this network may be generated and adjustments to the parameters may be made with subsequent simulations. Once the outputs from the various models have been obtained, they may be evaluated on their performance using a determined success metric. The best model or a good-enough model may be selected, and the processor circuit may execute that plan to achieve the desired input data to mirror the predicted ‘best outcome’ scenario. Additionally, the success metric itself may be a combination of the optimized outcomes, which may be weighed relative to each other. Success metrics may be dynamically established, and the process rerun and the equipment directions further modified.

In one embodiment, data may be generated, transmitted, and stored and may involve one or both of a protected space data source and the exposed space data source. The processor circuit may encrypt and decrypt data as needed at rest, during use, or in transit. Encryption keys and schema may be selected and implemented as informed by end use parameters and requirements. The processor circuit may evaluate and/or identify a decision boundary (that is, a boundary that separates desired behavior from undesired behavior) with regard to that data. If the processor circuit determines that some quantity of data is from a protected space data source and/or is operating within determined boundaries then the processor circuit, and the equipment being controlled, may operate normally. However, if the data is determined to be from an exposed space data source and/or it crosses the decision boundary, the processor circuit may respond. Suitable responses may be to power down determined equipment, signal an alert, run a diagnostic routine, perform a data backup (without overwriting existing backup data), isolate equipment (including by suspending some or all communication pathways), switch equipment or control operations to a safe mode of the control system, and/or initiate a safe mode state of the equipment (e.g., slow a vehicle to a safe and controlled stop). The safe mode may be, in one embodiment, a soft shutdown mode that it intended to avoid damage or injury based on the shutdown itself and in another embodiment may be a reboot and/or minimal reload of essential drivers and functionality.

Terms such as "processing," "computing," "calculating," or "determining" refer to operations carried out by the processor circuit, which may include computing systems or electronic devices that manipulate data represented as physical (electronic) quantities within memory or registers. One or more components may be described as "configured to," "configurable to," "operable/operative to," "adapted/adaptable to," or similar terms. Unless explicitly stated, these terms encompass components in both active and inactive states.

The drawings show, by way of illustration, specific embodiments in which the invention can be practiced. These embodiments are also referred to generally as “examples.” Such examples can include elements in addition to those shown or described. However, the present inventor also contemplates examples in which only those elements shown or described are provided. Moreover, the present inventor also contemplates examples using any combination or permutation of those elements shown or described (or one or more aspects thereof), either with respect to a particular example (or one or more aspects thereof), or with respect to other examples (or one or more aspects thereof) shown or described herein.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated. In this document, the terms “including” and “in which” are used as the plain-English equivalents of the respective terms “comprising” and “wherein.” Also, in the following aspects, the terms “including” and “comprising” are open-ended, that is, a system, device, article, composition, formulation, or process that includes elements in addition to those listed after such a term in a claim are still deemed to fall within the scope of that claim. Moreover, in the following aspects, the terms “first,” “second,” and “third,” etc. are used merely as labels, and are not intended to impose numerical requirements on their objects.

The above description is intended to be illustrative, and not restrictive. For example, the above-described examples (or one or more aspects thereof) may be used in combination with each other. Other embodiments can be used, such as by one of ordinary skill in the art upon reviewing the above description. The Abstract is provided to allow the reader to quickly ascertain the nature of the technical disclosure. It is submitted with the understanding that it will not be used to interpret or limit the scope or meaning of the claims. Also, in the above Detailed Description, various features may be grouped together to streamline the disclosure. This should not be interpreted as intending that an unclaimed disclosed feature is essential to any claim. Rather, inventive subject matter may lie in less than all features of a particular disclosed embodiment. Thus, the following aspects are hereby incorporated into the Detailed Description as examples or embodiments, with each aspect standing on its own as a separate embodiment, and it is contemplated that such embodiments can be combined with each other in various combinations or permutations.

What is claimed is:

1. A system for detecting anomalies in non-destructive test data, the system comprising:
a probe assembly configured to acquire non-destructive test data at a plurality of positions on an object; and
a processor circuit communicatively coupled to the probe assembly, the processor circuit configured to:
generate reference images corresponding to the plurality of positions based on the acquired non-destructive test data;
select a candidate image from among the reference images, the candidate image associated with a position from the plurality of positions;
determine similarity scores between the candidate image and at least a subset of the remaining reference images;
identify, based on the similarity scores, a reference image from among the at least a subset of the remaining reference images for comparison with the candidate image; and
detect an anomaly associated with the object at the position associated with the candidate image utilizing (i) a similarity threshold and (ii) a similarity score of the candidate image and the reference image.

2. The system of claim 1, wherein the processor circuit is configured to:
rank the reference images in a similarity ranking based on the similarity scores; and
select an Nth reference image in the similarity ranking to identify as the reference image, wherein N is a selected rank.

3. The system of claim 2, wherein the processor circuit is configured to generate vectorized representations of the reference images for comparison in an embedding space, and the similarity scores are determined using a vector distance or dot product, wherein the processor circuit is configured to store the vectorized representations of the reference images in an image vector database.

4. The system of claim 1, wherein the reference image is an Nth reference image in a similarity ranking of the at least a subset of the remaining reference images, and wherein N is greater than a longest expected sequence of consecutive anomalous images such that the N^{th} reference image corresponds to a non-anomalous region of the object.

5. The system of claim 4, further comprising an interface configured to display the candidate image with an indication of the anomaly, wherein the processor circuit is configured to generate a difference image via pixel subtraction using the candidate image and the N^{th} reference image, and the displayed indication of the anomaly is based on the difference image.

6. The system of claim 5, wherein the processor circuit is configured to:
generate a plurality of difference images, each difference image based on a respective candidate image and its corresponding N^{th} reference image; and
construct a composite difference image for the object from the plurality of difference images to visualize anomalies.

7. The system of claim 5, wherein the processor circuit is configured to post-process the difference image by applying any one or more of noise filtering, contrast enhancement, thresholding, or connected-component labeling.

8. The system of claim 1, wherein the processor circuit is configured to generate the reference images by generating image data based on the non-destructive test data and processing the image data via any one or more of normalization, smoothing, median filtering, or downsampling.

9. The system of claim 1, wherein the at least a subset of the remaining reference images used to determine the similarity scores excludes at least one of:
one or more reference images corresponding to positions within a determined positional proximity to the candidate image to reduce a similarity comparison of positionally consecutive anomalous images; or
one or more reference images corresponding to positions outside a determined positional proximity of the candidate image to constrain comparison to portions of the object having a common geometry or common material properties.

10. The system of claim 1, wherein to detect the anomaly, the processor circuit is configured to compare the similarity score between the candidate image and the identified reference image to the similarity threshold.

11. A method for detecting anomalies in non-destructive test data, the method comprising:
acquiring non-destructive test data at a plurality of positions on an object;
generating reference images corresponding to the plurality of positions based on the acquired non-destructive test data;
selecting a candidate image from the reference images, the candidate image associated with a position from the plurality of positions;
determining similarity scores between the candidate image and at least a subset of remaining reference images;
identifying, based on the similarity scores, a reference image to the candidate image from the at least a subset of remaining reference images; and
detecting an anomaly associated with the object at the position of the candidate image utilizing (i) a similarity threshold and (ii) a similarity score of the candidate image and the reference image.

12. The method of claim 11, identifying the reference image comprises:
ranking the reference images in a similarity ranking based on the similarity scores; and
selecting an Nth reference image in the similarity ranking to identify as the reference image, wherein N is a selected rank.

13. The method of claim 11, wherein the reference image is an N^{th} reference image in a similarity ranking of the at least a subset of the remaining reference images, and wherein N is greater than a longest expected sequence of consecutive anomalous images such that the N^{th} reference image corresponds to a non-anomalous region of the object.

14. The method of claim 11, comprising:
selecting an N^{th} reference image in a similarity ranking of the at least a subset of the remaining reference images to identify as the reference image, wherein N is a selected rank;
generating a difference image via pixel subtraction using the candidate image and the N^{th} reference image; and
displaying an indication of the anomaly based on the difference image.

15. The method of claim 14, further comprising post-processing the difference image by applying any one or more of noise filtering, contrast enhancement, thresholding, or connected-component labeling.

16. The method of claim 11, wherein generating the reference images comprises:
generating image data based on the non-destructive test data; and
processing the image data via any one or more of normalization, smoothing, median filtering, or downsampling.

17. The method of claim 11, wherein the at least a subset of the remaining reference images used to determine the similarity scores excludes reference images corresponding to positions within a determined positional proximity to the candidate image.

18. The method of claim 11, wherein the at least a subset of the remaining reference images used to determine the similarity scores excludes reference images corresponding to positions outside a determined positional proximity of the candidate image to constrain comparison to portions of the object having a common geometry or material properties.

19. A method for detecting anomalies in non-destructive test data, the method comprising:
acquiring non-destructive test data at a plurality of positions on object;
generating reference images corresponding to the plurality of positions based on the acquired non-destructive test data;
generating a vector database comprising vectorized representations of the reference images;
pairing each reference image to an N^{th} reference image based on similarity scores determined between each reference image and at least a subset of the remaining reference images, wherein N is a selected rank in a similarity ranking of the reference images; and
identifying one or more anomalies associated with the object based on paired reference images having similarity scores and based on a similarity threshold.

20. The method of claim 19, comprising:
generating a plurality of difference images via pixel subtraction based on a determined difference between each of the paired reference images; and
constructing a composite difference image for the object from the plurality of difference images to visualize the one or more anomalies.
